(19) United States
(12) Patent Application Publication
(10) Pub. No.: US 2007/0267263 A1
(43) Pub. Date: Nov. 22, 2007

(54) OVERRUNNING CLUTCH

(76) Inventor: Jack Eric Pederson, Saline, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/419,383

(22) Filed: May 19, 2006

(51) Int. Cl. F16D 41/06

(52) U.S. Cl. 192/45

(57) ABSTRACT

An overrunning clutch is provided with improved structural characteristics to facilitate the use of grease lubrication. The clutch includes a hub disposed about a rotational axis and defining an inner raceway. A driven member is supported on the hub by a bearing and defines a radially inner surface spaced from the inner raceway of the hub. An outer race is disposed between the inner surface and inner raceway and defines a plurality of cam surfaces opposing the inner race. A plurality of rollers are disposed between the inner raceway and the outer race. Springs urge the rollers into engagement with the cam surfaces in the outer race. A seal is disposed between the rollers and bearing and the inner raceway, cam surfaces, rollers and bearing are lubricated with grease.

### BACKGROUND OF THE INVENTION

1. Field of the Invention

This invention relates to overrunning clutches and, in particular, to an overrunning clutch having an improved structure that facilities grease lubrication of the clutch.

2. Discussion of Related Art

Rotational coupling devices such as clutches are used to control transfer of torque between rotational bodies. An overrunning clutch is designed to drive in one direction while freewheeling or overrunning in the opposition direction. In the driving direction, the clutch also freewheels if the rotational speed of the driven body exceeds the rotational speed of the driving body. One of the benefits of an overrunning clutch is that it allows for the overrunning of large inertia loads upon stopping and prevents any back-driving damage that may occur to the drive system. Overrunning clutches are commonly used in applications such as dual motor/engine drives, conveyors belts, creep and starter drives and the disengagement of centrifugal masses.

The bearing and friction surfaces of overrunning clutches are provided with lubricant, such as grease, to reduce friction and heat. In conventional overrunning clutches, however, the grease can degrade prematurely into its individual components and can cause the energizing mechanism of the clutch (typically spring loaded plungers or cages) to seize and even fail.

The inventors herein have recognized a need for a clutch that will minimize and/or eliminate one or more of the above-identified deficiencies.

### SUMMARY OF THE INVENTION

The present invention provides an overrunning clutch.

An overrunning clutch in accordance with the present invention includes a hub disposed about an axis of rotation and defining an inner race. A driven member is supported on the hub by a bearing. The driven member defines a radially inner surface spaced from the inner raceway. An outer race is disposed between the radially inner surface of the driven member and the inner raceway of the hub. The outer race has a radially inner surface that defines a plurality of cam surfaces opposing the inner raceway. A plurality of rollers are disposed between the inner raceway and outer race. The clutch further includes a plurality of springs. Each spring of the plurality of springs urges a corresponding roller into engagement with a corresponding cam surface in the outer race. Finally, the clutch includes a seal disposed axially between the rollers and the bearing. The inner raceway, the plurality of cam surfaces, the rollers and the bearing are lubricated with grease.

An overrunning clutch in accordance with the present invention represents an improvement over conventional overrunning clutches. In particular, the inventive clutch facilitates the use of grease lubrication in the clutch through improved lubricant retention and the use of an energizing mechanism (in the form of a loose roller mechanism) that better withstands degradation of the lubricant.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a diagrammatic view of a power transmission assembly incorporating an overrunning clutch in accordance with the present invention.

FIG. 2 is a cross-sectional view of an overrunning clutch in accordance with the present invention.

FIG. 3 is an enlarged sectional view of a portion of an overrunning clutch in accordance with the present invention.

FIG. 4 is a partial cross-sectional view of a portion of an overrunning clutch in accordance with the present invention.

### DETAILED DESCRIPTION OF EMBODIMENTS OF THE INVENTION

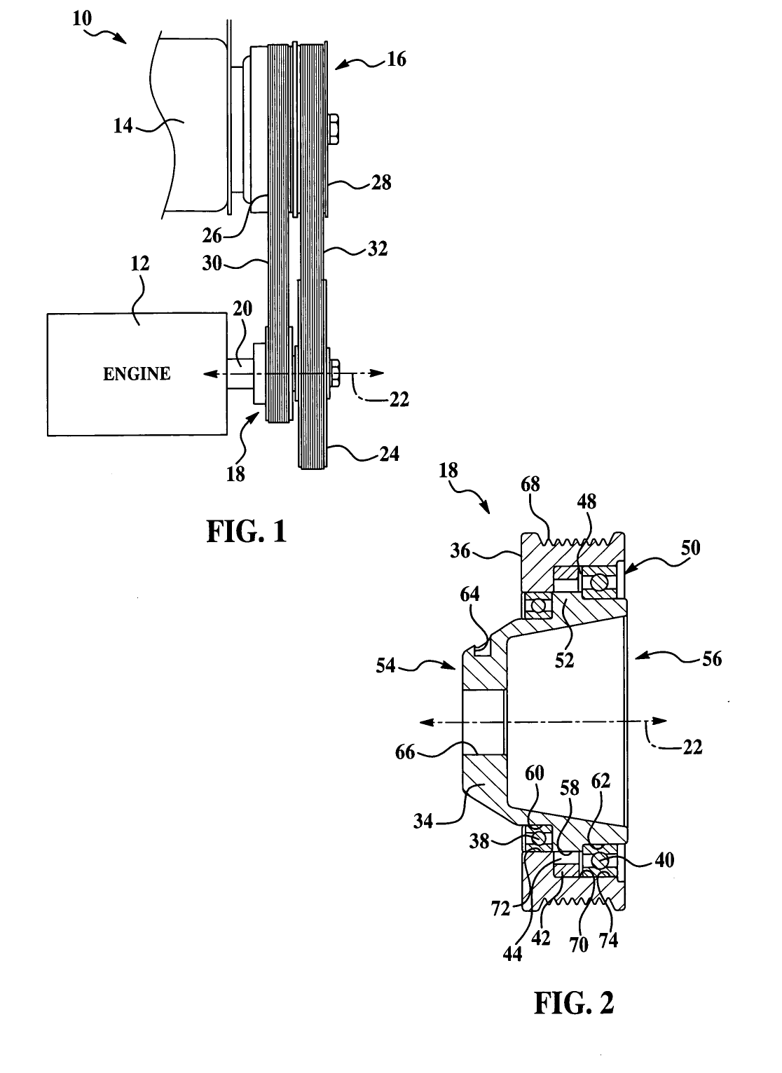

Referring now to the drawings wherein like reference numerals are used to identify identical components in the various views, FIG. 1 illustrates a power transmission assembly 10. Assembly 10 includes an engine 12, at least one accessory device 14, a clutch 16 mounted to device 14, and an overrunning clutch 18 in accordance with the present invention. Assembly 10 is provided to transmit power from a power source such as engine 12 to accessories such as device 14. Assembly 10 may find particular application in vehicles in which engine power is used to drive accessory devices such as alternators, air conditioners, pumps and other devices. It should be understood, however, that assembly 10 may be used in a wide variety of applications.

Engine 12 provides a driving torque and is conventional in the art. Engine 12 may comprise an internal combustion engine and includes a crankshaft 20 extending therefrom along a rotational axis 22. Crankshaft 20 supports clutch 18 and a pulley 24.

Device 14 may assume a wide variety of forms and perform a wide variety of functions depending on the application of assembly 10. In the illustrated embodiment, device 14 comprises an air pump for use in supplying pressurized air to various vehicular systems (e.g., brakes). Device 14 may alternatively comprise, for example only, various fluid pumps, fans, an alternator, or a vehicle air conditioning unit.

Clutch 16 selectively transmits torque from engine 12 to accessory device 14. Clutch 16 is conventional in the art and may comprise an electromagnetic clutch. Clutch 16 includes two pulleys 26, 28 that are coupled to overrunning clutch 18 and pulley 24, respectively, through belts 30, 32. Upon engagement of clutch 16, pulleys 26, 28 (which may function as a rotor and an armature) are brought into engagement for rotation together. In this manner, torque is transmitted from engine 12 through pulley 24 and belt 32 such that accessory device 14 is driven at the same speed as crankshaft 20. Overrunning clutch 18 freewheels during engagement of clutch 16 as discussed in greater detail hereinbelow. Upon disengagement of clutch 16, pulleys 26, 28 disengage from one another and torque is transmitted from engine 12 through clutch 18 and belt 30. In this manner, accessory device 14 may be driven at a lower speed to reduce power consumption.

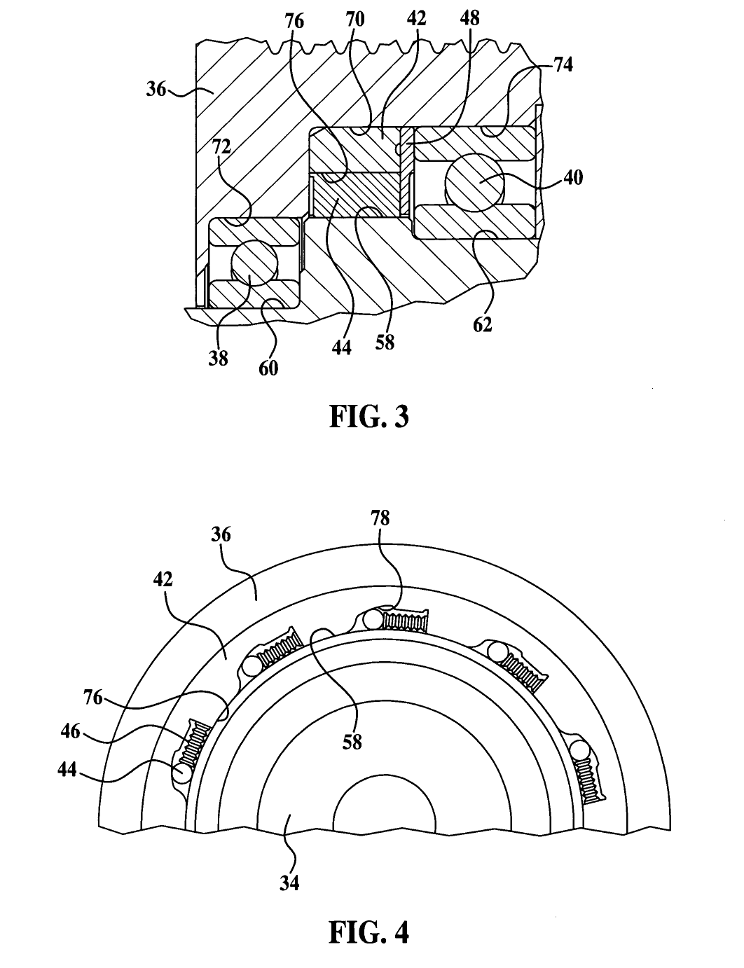

Overrunning clutch 18 is provided to selectively transmit torque from a torque transmitting device, such as engine 12, to a torque receiving device, such as accessory device 14. In power transmission assembly 10, clutch 18 is provided to allow accessory devices to operate at a reduced speed. Referring to FIGS. 2-4, clutch 18 may include a hub 34, a driven member such as pulley 36, bearings 38, 40, an outer race 42, rollers 44, springs 46 and seals 48, 50.

Hub 34 is mounted on crankshaft 20 and is configured to transfer torque to cam 42 through rollers 44. Hub 34 is disposed about, and may be centered on, axis 22. Hub 34 has an annular radially outwardly projecting flange 52 intermediate the axial ends 54, 56 of hub 34. Flange 52 defines shoulders against which bearings 38, 40 are disposed. Flange 52 also creates a stepped outer diameter that defines an inner raceway 58 and first and second inner bearing surfaces 60, 62 on either side of raceway 58. The outer diameter of hub 34 at bearing surface 60 is less than the outer diameter of hub 34 at bearing surface 62. Hub 34 tapers towards end 54 and has a substantially conical shape proximate end 54. Hub 34 may include a plurality of circumferentially spaced recesses 64 proximate end 54 for use in removing clutch 18. Recesses 64 may be spaced equidistant from one another. Hub 34 defines a stepped diameter bore 66 configured to receive crankshaft 20. The smaller diameter portion of bore 66 is configured to received a threaded portion of crankshaft 20.

Pulley 36 is provided to transmit torque from outer race 42 to device 14 through belt 30 and pulley 26. Pulley 36 is supported on hub 34 by bearings 38, 40. Pulley 36 defines a plurality of grooves 68 in a radially outer surface configured to grip belt 30. Pulley 36 has a stepped inner diameter that defines a radially inner surface 70 radially spaced from inner raceway 58 and outer bearing surfaces 72, 74 disposed on either side of surface 70 and radially spaced from inner bearing surfaces 60, 62, respectively, of hub 34. The diameter of pulley 36 at surfaces 70, 74 is equal. The diameter of pulley 36 at bearing surface 72, however, is less than the diameter at surfaces 70, 74 and is about equal to the diameter of hub 34 at raceway 58.

Bearings 38, 40 are provided to allow relative rotation of pulley 36 and hub 34 in an overrunning condition. Bearings 38, 40 are conventional in the art and may comprise roller bearings. Bearing 38 is disposed between bearing surfaces 60, 72 while bearing 40 is disposed between bearing surfaces 62, 74.

Outer race 42 transfers torque from rollers 44 to pulley 36. Race 42 is disposed between surface 70 of pulley 36 and raceway 58 of hub 34 and includes a radially inner surface 76 opposing inner raceway 58. Referring to FIG. 4, surface 76 defines a plurality of cam surfaces 78 spaced circumferentially about race 42 and opposing raceway 58. In accordance with one aspect of the present invention, each cam surface 78 is configured to maintain a substantially constant grip angle between: (i) a corresponding roller 44 and surface 78 of outer race 42; and (ii) the roller 44 and inner raceway 58. The grip angle refer to the angle between (a) a straight line extending through the points of contact of roller 44 with raceway 58 and cam surface 78 and (b) a straight line extending through the center of roller 44 and the point of contact of roller 44 with raceway 58 or cam surface 78. The substantially constant grip angle helps to limit the impact of lubricant breakdown and torsional vibration from engine 12 on clutch 18. In accordance with another aspect of the present invention, outer race 42 is press-fit into pulley 36. The press-fit relationship stiffens outer race 42 and preloads race 42 to prevent deflection of race 42 and skidding of rollers 44 and does so at a lower cost compared to conventional clutches.

Rollers 44 are provided to selectively transmit torque between hub 34 and race 42. Rollers 44 are conventional in the art and may be made from conventional metals and metal alloys. Rollers 44 may be circular in cross-section. Rollers 44 are not retained by a cage and clutch 18 is therefore a loose roller clutch. The use of rollers 44 rather than sprags and the loose configuration of rollers 44 rather than using a cage helps to limit the impact of lubricant breakdown and torsional vibration from engine 12 on clutch 18. Rollers 44 remain engaged with both inner raceway 58 and cam surfaces 78 as long as pulley 36 is rotating at the same speed, and in the same direction as hub 34. If pulley 36 begins to rotate at a higher speed than hub 34 or in a different direction, rollers 44 become disengaged from inner raceway 58 and cam 42 and pulley 36 are able to freewheel relative to hub 34.

Springs 46 bias rollers 44 into engagement with cam surfaces 78. Springs 46 are conventional in the art and may comprise wave springs or other conventional springs. Springs 46 are inserted in the open space between the inner raceway 58 and cam surfaces 78 and centrifugal forces prevent springs 46 from contacting hub 34. In accordance with one aspect of the present invention, springs 46 act directly on rollers 44 as opposed to driving rollers 44 with spring energized plungers or a cage or other actuating members. This structure permits clutch 18 to better withstand the breakdown of lubricants such as grease and the potential impact of the grease on spring force thereby reducing the possibilities clutch 18 will seize or fail.

Seals 48, 50 are provided to retain lubricant within clutch 18 while reducing the possible frictional impact of the seals. Seals 48 also serves to inhibit lubricant flow between bearing 40 and the working surfaces of clutch 18 (i.e., raceway 58, cam surfaces 78 and rollers 40) to prevent cross-contamination. Seals 48, 50 may comprise labyrinth seals having a tortured flow path formed therein that limits the ability of fluid to escape while limiting the need for direct contact by seals 48, 50 with moving components of clutch 18. Seal 48 is disposed axially between rollers 44 and bearing 40 and also prevents rollers 44 (which again are loose rollers unrestrained by a cage) from contacting and sticking to bearing 40. Seal 50 is disposed on an opposite side of bearing 40 from seal 48. Seals 48, 50 may be made from metal or metal alloys such as steel and may be coated with an anti-friction coating such as manganese phosphate (which also acts as a rust inhibitor).

An overrunning clutch in accordance with the present invention represents a significant improvement relative to conventional clutches. The inventive clutch 18 facilitates the use of grease lubrication in the clutch through improved lubricant retention and the use of an energizing mechanism (in the form of a loose roller mechanism and constant grip angles) that better withstands degradation of the lubricant.

While the invention has been shown and described with reference to one or more particular embodiments thereof, it will be understood by those of skill in the art that various changes and modifications can be made without departing from the spirit and scope of the invention.

We claim:

1. An overrunning clutch, comprising:
a hub disposed about an axis of rotation and defining an inner raceway;
a driven member supported on said hub by a first bearing, said driven member defining a radially inner surface spaced from said inner raceway;
an outer race disposed between said radially inner surface of said driven member and said inner raceway of said hub, said outer race having a radially inner surface defining a plurality of cam surfaces opposing said inner raceway;
a plurality of rollers disposed between said inner raceway and said outer race
a plurality of springs, each spring of said plurality of springs urging a corresponding roller into engagement with a corresponding cam surface in said outer race; and,
a first seal disposed axially between said rollers and said first bearing
wherein said inner raceway, said plurality of cam surfaces, said rollers and said first bearing are lubricated with grease.

2. The overrunning clutch of claim 1, further comprising a second seal disposed at an opposite axial end of said first bearing from said first seal.

3. The overrunning clutch of claim 1, further comprising a second bearing disposed between said driven member and said hub, said outer race intermediate said first and second bearings relative to said axis of rotation.

4. The overrunning clutch of claim 1 wherein said driven member comprises a pulley.

5. The overrunning clutch of claim 1 wherein said outer race engages said driven member in a press-fit relationship.

6. The overrunning clutch of claim 1 wherein each cam surface of said plurality of cam surfaces in said outer race is configured to maintain a substantially constant grip angle between a corresponding roller of said plurality of rollers and said outer race.

7. The overrunning clutch of claim 1 wherein said first seal comprises a labyrinth seal.

8. The overrunning clutch of claim 1 wherein said first seal includes an anti-friction coating.

9. A power transmission assembly, comprising:
an internal combustion engine, a shaft extending from said engine and configured for rotation about a rotational axis;
an accessory device;
an accessory mounted clutch mounted to said accessory device and selectively transmitting torque from said shaft of said engine to said accessory device;
an overrunning clutch, including:
a hub disposed about said shaft and said axis of rotation and defining an inner raceway;
a driven member supported on said hub by a first bearing, said driven member defining a radially inner surface spaced from said inner raceway;
an outer race disposed between said radially inner surface of said driven member and said inner raceway of said hub, said outer race having a radially inner surface defining a plurality of cam surfaces opposing said inner raceway;
a plurality of rollers disposed between said inner and outer race
a plurality of springs, each spring of said plurality of springs urging a corresponding roller into engagement with a corresponding cam surface in said outer race; and,
a first seal disposed axially between said rollers and said first bearing
wherein said inner race, said plurality of cam surfaces, said rollers and said first bearing of said overrunning clutch are lubricated with grease, said overrunning clutch is coupled to said accessory device and transmits torque to said accessory device when said accessory mounted clutch is disengaged, and said accessory device is driven at a first speed responsive to said overrunning clutch and at a second speed responsive to said accessory mounted clutch, said first speed less than said second speed.

10. The power transmission device of claim 9, further comprising a second seal disposed at an opposite axial end of said first bearing from said first seal.

11. The power transmission device of claim 9, further comprising a second bearing disposed between said driven member and said hub, said outer race intermediate said first and second bearings relative to said axis of rotation.

12. The power transmission device of claim 9 wherein said driven member comprises a pulley.

13. The power transmission device of claim 9 wherein said outer race engages said driven member in a press-fit relationship.

14. The overrunning clutch of claim 9 wherein each cam surface of said plurality of cam surfaces in said outer race is configured to maintain a substantially constant grip angle between a corresponding roller of said plurality of rollers and said outer race.

15. The overrunning clutch of claim 9 wherein said first seal comprises a labyrinth seal.

16. The power transmission device of claim 9 wherein said first seal includes an anti-friction coating.
